(19) United States
(12) Patent Application Publication
(10) Pub. No.: US 2026/0177898 A1
(43) Pub. Date: Jun. 25, 2026

(54) Atmosphere Image Projection Apparatus

(71) Applicant: Zhongshan Bo Lang Electronics Technology Co., Ltd., Zhongshan (CN)

(72) Inventors: Gang WANG, Zhongshan (CN); Kexian LIU, Zhongshan (CN)

(21) Appl. No.: 19/275,905

(22) Filed: Jul. 21, 2025

(30) Foreign Application Priority Data
Dec. 20, 2024 (CN) 202411892719.0

(51) Int. Cl. G03B 21/20; G03B 21/00; G03B 21/14

(52) U.S. Cl. CPC G03B 21/208; G03B 21/006; G03B 21/142; G03B 21/2033; G03B 21/2066

(57) ABSTRACT

The present application provides an atmosphere image projection apparatus, including: a display projection module and a laser projection module provided adjacent to the display projection module. The laser projection module includes a laser assembly and a first optical path module, where a single laser beam emitted from the laser assembly passes through the first optical path module to form a plurality of laser beams and is projected into space. The display projection module includes a light source assembly, a display screen, and a second optical path module, where content played on the display screen is guided by the second optical path module to form dynamic image, which is projected between the plurality of laser beams. Compared to atmosphere image projection apparatuses of the prior art, the present application projects imagery via the display screen, obviating the need for films, which results in lower costs.

### TECHNICAL FIELD

The present application relates to the technical field of projection lamps, and more particularly, to an atmosphere image projection apparatus.

### BACKGROUND

The atmosphere starry sky projection is a projection method where romantic scenes such as astronomical starry skies and natural landscapes are projected onto walls and ceilings by light emitted from a projection apparatus. This projection method can transform a home's room into a scene of a star-filled sky, the Milky Way, or natural landscapes, creating a sense of immersion and fostering a very comfortable, quiet, pleasant, romantic, and relaxing space. An ambiance light is a lamp capable of projecting patterns onto walls, floors, or screens. Ambiance lights are commonly used in stage and entertainment settings such as theaters, broadcast studios, bars, and discos, and can project monochromatic or multicolored patterns of water ripples, starry skies, or various lines, thereby creating warm, romantic, and immersive scenes.

With the continuous progress and development of society, people's living standards have constantly improved, and ambiance lights have gradually entered thousands of households. In prior art solutions, a motor is typically used in coordination with a pattern-effect plate referred to in the original as an “interference plate” to achieve dynamic projection effects. However, the projected image changes periodically, which may lead to aesthetic fatigue after prolonged viewing. To address this, a set of static images can be superimposed on a starry sky image serving as a dynamic background to create a more three-dimensional visual effect. However, such ambiance lights are typically presented in the manner of a slide show, often requiring manual switching of images, which is a cumbersome method of operation. Additionally, the images are usually on projection films; the more projection films there are, the more scene selections are available, but the costs increase correspondingly.

### SUMMARY

To solve or at least partially solve the above technical problems, the present application provides an atmosphere image projection apparatus, including:
a display projection module and a laser projection module provided adjacent to the display projection module;
where the laser projection module includes a laser assembly and a first optical path module, where a single laser beam emitted from the laser assembly passes through the first optical path module to form a plurality of laser beams and is projected into space; and
the display projection module includes a light source assembly, a display screen, and a second optical path module, where content played on the display screen is guided by the second optical path module to form dynamic image, which is projected between the plurality of laser beams.

A further technical solution may be that the first optical path module includes:
a first grating and a second grating provided along the optical path of the laser;
the single laser beam emitted from the laser assembly is diffracted by the first grating into a plurality of laser beams, and is then secondarily diffracted by the second grating to form an irregular optical path.

A further technical solution may be that a density of a diffraction pattern of the first grating is greater than a density of a diffraction pattern of the second grating.

A further technical solution may be that the first optical path module further includes:
a rotating shaft and a rotating disk sleeved on the rotating shaft, where the rotating disk can be driven to rotate on the rotating shaft, the rotating disk is located between the first grating and the second grating, and the rotating disk is provided with a plurality of light-passing apertures for the laser to pass through.

A further technical solution may be that diameters of the plurality of light-passing apertures are of different sizes; and/or,
the plurality of light-passing apertures are distributed on the rotating disk in an irregular manner.

A further technical solution may be that the second grating is connected with the rotating disk to rotate therewith.

A further technical solution may be that the laser projection module further includes: a drive assembly, connected with the rotating disk, for driving the rotating disk to rotate.

A further technical solution may be that the drive assembly includes:
a drive motor;
a reduction gear set, connected with the drive motor, where the reduction gear set is connected with the rotating disk and the second grating, respectively, to drive the rotating disk and the second grating to rotate at different speeds.

A further technical solution may be that the light source assembly includes a first light source and a light-focusing element;
the second optical path module includes an optical lens and several lenses;
the first light source, the light-focusing element, the display screen, and the optical lens are arranged sequentially along the optical path followed by the second optical path module.

A further technical solution may be that the display screen is a liquid crystal display screen, and the light emitted from the light source assembly illuminates the liquid crystal display screen to serve as a backlight.

A further technical solution may be that the lenses include:
a first lens, provided between the light-focusing element and the display screen;
a second lens, provided between the display screen and the optical lens;
the optical lens includes a convex lens, a concave lens, and a fisheye lens element, arranged sequentially along the optical path followed by the second optical path module.

A further technical solution may be that the second optical path module further includes a reflecting mirror, where the reflecting mirror is provided between the second lens and the optical lens, and the reflecting mirror is provided at an angle with respect to the display screen.

Compared to atmosphere image projection apparatuses of the prior art, the present application projects imagery via a display screen, obviating the need for films, which results in lower costs. Furthermore, the display screen can provide a richer and more diverse selection of imagery, with natural image transitions and convenient operation, thereby significantly enhancing the user experience.

### BRIEF DESCRIPTION OF THE DRAWINGS

To explain the implementations of the present application more clearly, a brief introduction to the relevant drawings will be provided below. It can be understood that the drawings in the following description are only for illustrating some implementations of the present application, and those ordinary skilled in the art may also obtain many other technical features and connection relationships not mentioned herein based on these drawings.

FIG. 1 is a schematic structural diagram of an atmosphere image projection apparatus provided in one embodiment of the present application.

FIG. 2 is a schematic structural diagram of an atmosphere image projection apparatus provided in another embodiment of the present application.

FIG. 3 is another schematic structural diagram of an atmosphere image projection apparatus provided in one embodiment of the present application.

FIG. 4 is another schematic structural diagram of an atmosphere image projection apparatus provided in one embodiment of the present application.

### REFERENCE NUMERALS

1 Display Projection Module
11 Light Source Assembly
111 First Light Source
112 Light-focusing Element
12 Display Screen
13 Second Optical Path Module
131 Optical Lens
131a Convex Lens
131b Concave Lens
131c Fisheye Lens
132 First Lens
133 Second Lens
134 Reflecting Mirror
2 Laser Projection Module
21 Laser Assembly
22 First Optical Path Module
221 Rotating Disk
221a Light-passing Aperture
222 Second Grating
223 First Grating
224 Drive Assembly

### DETAILED DESCRIPTION

The technical solutions in the embodiments of the present application will be described in detail below in conjunction with the accompanying drawings in the embodiments of the present application.

The inventors of the present application have found that in prior solutions, motors are used to drive the rotation of light-transmitting structures to achieve motion change of the projected image. However, the projected image changes periodically, which may lead to aesthetic fatigue after prolonged viewing, and the method for switching the projected image is abrupt, making it difficult to present relatively stunning scenes.

In view of this, the present application provides an atmosphere image projection apparatus capable of presenting more realistic and diverse dynamic scenes to enhance the user experience.

### Embodiment 1

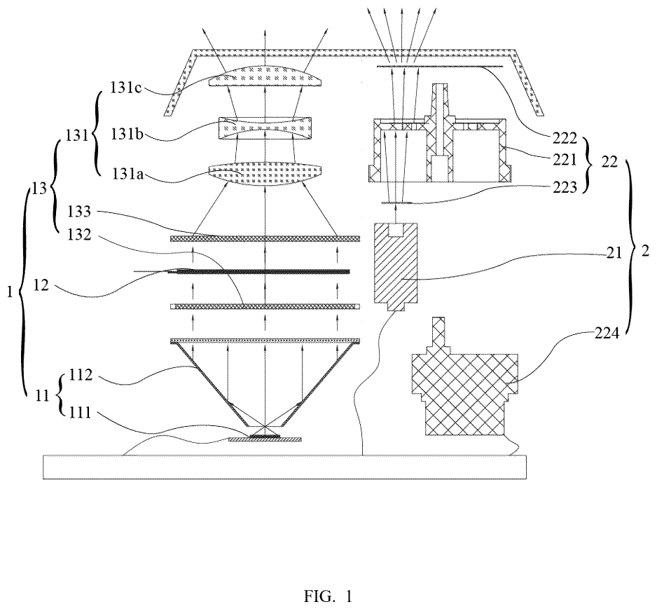

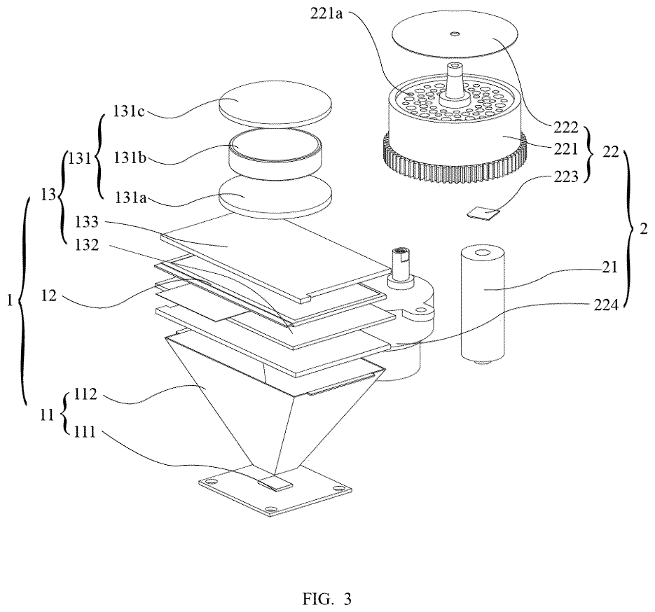

The first embodiment of the present application proposes an atmosphere image projection apparatus, as shown in FIGS. 1 and 3, including:
a display projection module 1 and a laser projection module 2 provided adjacent to the display projection module 1;
the laser projection module 2 includes a laser assembly 21 and a first optical path module 22, where a single laser beam emitted from the laser assembly 21 passes through the first optical path module 22 to form a plurality of laser beams and is projected into space;
the display projection module 1 includes a light source assembly 11, a display screen 12, and a second optical path module 13, where content played on the display screen 12 is guided by the second optical path module 13 to form dynamic image, which is projected between the plurality of laser beams.

The content played on the display screen 12 can form dynamic image and be projected into space. The single laser beam emitted from the laser assembly 21 passes through the first optical path module 22 to form a plurality of laser beams and is projected into space. The plurality of laser beams illuminate space to form a starry sky image. The starry sky image and the dynamic image at least partially overlap in space. The starry sky image has a large coverage area, thus providing a more expansive dynamic visual experience. By projecting imagery via the display screen 12, there is no need to set up films, resulting in lower costs, and the display screen 12 can offer a richer and more diverse selection of imagery with natural transitions and convenient operation. Compared to the prior art, by combining the starry sky image and the dynamic image, this implementation compensates for the defect of the narrow visible range of the dynamic image and avoids the defect of the starry sky image feeling monotonous due to too little variation. The complementary combination of the two significantly enhances the user experience.

In some preferred embodiments, the first optical path module 22 includes:
a first grating 223 and a second grating 222 provided along the optical path of the laser;
the single laser beam emitted from the laser assembly 21 is diffracted by the first grating 223 into a plurality of laser beams, and is then secondarily diffracted by the second grating 222 to form an irregular optical path.

Through the arrangement of the first grating 223 and the second grating 222, on one hand, the single laser beam from the laser assembly 21 is first diffracted into a plurality of beams by the first grating 223, and then further diffracted into even more beams by the secondary diffraction of the second grating 222. This increases the number of laser beams, making the starry sky image formed by the projected beams richer. On the other hand, as the single laser beam from the laser assembly 21 sequentially passes through the first grating 223 and the second grating 222, the diffraction effects of these gratings make the optical paths of the laser beams projected by the laser projection module 2 more complex and the projection range wider. This results in a starry sky image formed by the projected laser beams that more closely resembles a realistic starry sky effect.

Furthermore, to further enhance the diffraction effect of the gratings, a density of a diffraction pattern of the first grating 223 is greater than a density of a diffraction pattern of the second grating 222.

In this embodiment, the display screen 12 may be a liquid crystal display LCD screen, which has advantages such as low power consumption, small size, and zero radiation. The light emitted from the light source assembly 11 can illuminate the display screen 12 as a backlight. In another embodiment, the display screen 12 may also be a self-luminous display, such as an LED screen or an OLED screen, as long as the display screen 12 is capable of forming dynamically displayed content.

The second optical path module 13 may include an optical lens 131 and several lenses. The light source assembly 11 includes a first light source 111 and a light-focusing element 112. The first light source 111, the light-focusing element 112, the display screen 12, and the optical lens 131 are arranged sequentially along the optical path followed by the second optical path module 13, with the various lenses interspersed between the components of the second optical path module 13. The cooperative use of the optical lens 131, the several lenses, and the light-focusing element 112 can make the projected dynamic image clearer and improve the luminous efficiency.

To improve the clarity of imaging, convex lenses that converge light can be used. However, if ordinary convex lenses are used, since the refraction of light only occurs at the interface of the medium and the lens is relatively thick, the light may attenuate during propagation, potentially causing the edges to appear dim and blurry. Therefore, in this embodiment, the lens can be a Fresnel lens. A Fresnel lens has one smooth surface and another surface engraved with concentric circles of increasing size. Its texture is designed based on the principles of light interference, diffraction, and requirements for relative sensitivity and reception angle. Thus, a Fresnel lens may eliminate the part of the light that travels in a straight line, retaining only the refracting curved surfaces, which saves a significant amount of material while achieving the same light-condensing effect as a convex lens. In other words, the cost of a Fresnel lens is much lower than that of an ordinary convex lens.

The lenses may include: a first lens 132, provided between the light-focusing element 112 and the display screen 12; and a second lens 133, provided between the display screen 12 and the optical lens 131. The optical lens 131 may include a convex lens 131a, a concave lens 131b, and a fisheye lens 131c arranged sequentially, with the convex lens 131a provided on the side closer to the display screen 12.

The provided first lens 132 and second lens 133 can better converge light, preventing the waste of light energy. The convex lens 131a can converge light, while the concave lens 131b can diverge light. Therefore, by designing the parameters of the convex lens 131a and the concave lens 131b, the projection effect of the imagery, such as the size of the image and image distance, the focusing range, and the imaging quality, can be well ensured. The fisheye lens 131c, as a wide-angle lens, allows the lens to achieve the maximum photographic angle of view. Thus, in a confined space like that of the atmosphere image projection apparatus, a large area can be projected, which improves the spatial utilization of the apparatus.

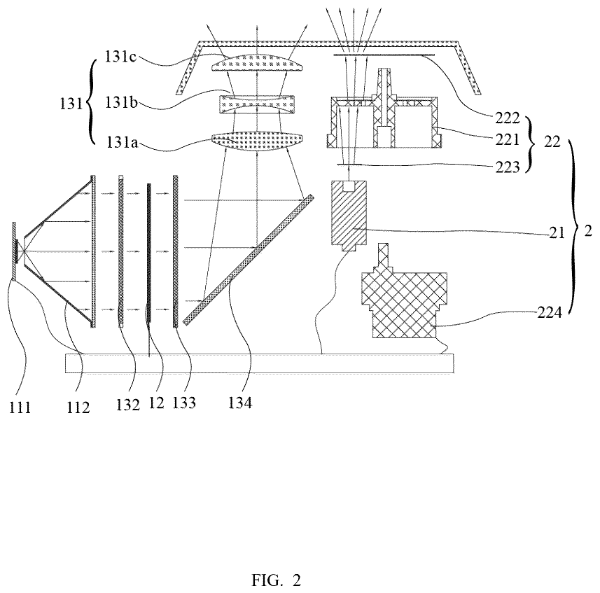

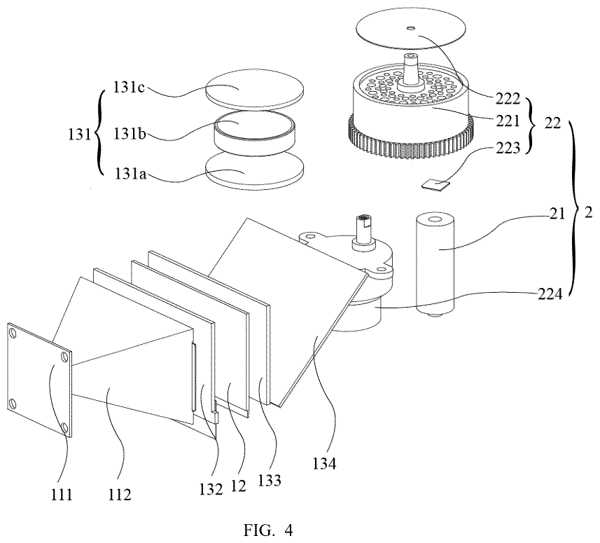

In another embodiment, as shown in FIGS. 2 and 4, the second optical path module 13 can also include: a reflecting mirror 134, provided between the second lens 133 and the optical lens 131, with the reflecting mirror 134 forming an angle with the display screen 12. When the reflecting mirror 134 is set at an angle to the display screen 12, it can change the direction of light propagation, causing the light exiting the second lens 133 to be reflected by the reflecting mirror 134 and then incident on the optical lens 131. Optionally, the reflecting mirror 134 forms a 45° angle with the display screen 12, causing the light exiting the second lens 133 to be perpendicular to the light incident on the optical lens 131.

Comparing FIGS. 1 and 2, it is evident that when the sizes of the lenses and the reflecting mirror 134 are the same, the dimensions of the optical lens 131 and other components in the embodiment shown in FIG. 2 may be relatively smaller. Similarly, when the sizes of the optical lens 131 and other components are the same, the dimensions of the lenses and the reflecting mirror 134 may be smaller. That is to say, by using the reflecting mirror 134, this embodiment can further improve the spatial utilization of the atmosphere image projection apparatus.

In this embodiment, the light emitted from the first light source 111 is collected by the light-focusing element 112, projected onto the first lens 132, and then converted to the liquid crystal display 12 screen as a backlight. The content on the display screen 12 may undergo a first 3D conversion through the second lens 133, then be projected onto the convex lens 131a and concave lens 131b for a second conversion, and finally be imaged through the fisheye lens 131c.

The imagery projected by the laser projection module 2 and the display projection module 1 is then refracted by an irregular dust-proof light-transmitting cover, ultimately forming the dynamic image and the starry sky image and are projected into space. For example, the starry sky image may appear as a rotating night sky, and the dynamic image could be a rotating Saturn. The starry sky image and the dynamic image at least partially overlap in space, resulting in a final projection that is a dynamic image with Saturn as the foreground and the night sky as the background. Therefore, this implementation provides an atmosphere image projection apparatus with a wide-angle view and a stereoscopic effect. The image playback is smooth, the image selection is diverse, the structure is compact, and the cost is low, which significantly improves the user experience.

It is worth mentioning that the display projection module 1 and the laser projection module 2 of the atmosphere image projection apparatus in this implementation may be used independently according to user needs, or they may be used in combination.

### Embodiment 2

The second embodiment of the present application proposes an atmosphere image projection apparatus, which is a further improvement based on the first embodiment. The improvement lies in that, as shown in FIGS. 1-4, the first optical path module 22 further includes:
a rotating shaft and a rotating disk 221 sleeved on the rotating shaft, where the rotating disk 221 can be driven to rotate on the rotating shaft, the rotating disk 221 is located between the first grating 223 and the second grating 222, and the rotating disk 221 is provided with a plurality of light-passing apertures 221a for the laser to pass through.

When the plurality of laser beams formed by diffraction from the first grating 223 pass through the rotating disk 221, some of the laser beams are blocked by the rotating disk 221, while another portion of the laser beams passes through the light-passing apertures 221a towards the second grating 222. As the rotating disk 221 rotates, the light-passing apertures 221a on the disk also rotate, causing the plurality of laser beams diffracted by the first grating 223 to alternately pass through the light-passing apertures 221a towards the second grating 222. This causes the light spots formed by the laser beams illuminating space to exhibit a twinkling effect, achieving the effect of a shimmering, flickering starry sky in the projected image.

It is worth mentioning that the single laser beam from the laser assembly 21 may be diffracted into a plurality of laser beams after passing through the first grating 223. Any one of these beams, after passing through the second grating 222, may also be diffracted into a plurality of laser beams with irregular optical paths. The light spots formed by these lasers projected into space have a wide and irregular distribution. In this embodiment, the rotating disk 221 is placed between the first grating 223 and the second grating 222 for blocking some of the laser beams diffracted by the first grating 223, thereby causing the light spots formed by the laser beams in space to have a twinkling appearance. The wide and irregular distribution of these light spots makes the twinkling effect of the stars in the projected starry sky image more closely resemble a real starry sky.

In other preferred embodiments, the diameters of the plurality of light-passing apertures 221a are of different sizes. In this embodiment, by setting the diameters of the light-passing apertures 221a to different sizes, the variation in how the rotating disk 221 blocks the laser beams during its rotation is increased. This enhances the random, non-periodic nature of the twinkling of the light spots formed by the laser beams in space. Similarly, in other preferred embodiments, the plurality of light-passing apertures 221a are distributed on the rotating disk 221 in an irregular manner.

In some embodiments, the laser projection module 2 further includes: a drive assembly 224, connected with the rotating disk 221, for driving the rotating disk 221 to rotate. For example, this drive assembly 224 may be a motor connected with the rotating disk 221 via gears.

### Embodiment 3

This embodiment is a further improvement based on the second embodiment. As shown in FIGS. 1-4, the improvement is that: the second grating 222 is connected with the rotating disk 221 to rotate therewith.

As described above, the single laser beam from the laser assembly 21 may be diffracted into a plurality of laser beams after passing through the first grating 223. Each of these beams may then be diffracted by the second grating 222 into another plurality of laser beams with irregular optical paths. The light spots formed by these lasers projected into space constitute the starry sky image, with each light spot representing a star. By configuring the second grating 222 to rotate with the rotating disk 221, the plurality of laser beams diffracted by the second grating 222 exhibit non-periodic movement, thereby causing the projected light spots to move, achieving the effect of stars moving irregularly.

In some embodiments, the drive assembly 224 includes:
a drive motor;
a reduction gear set, connected with the drive motor.

Where, the drive motor provides rotational driving force, while the reduction gear set may reduce the motor's speed and increase its torque, making the rotation of the rotating disk 221 more stable and controllable. It is worth mentioning that in this embodiment, the reduction gear set is connected with the rotating disk 221 and the second grating 222 respectively, to drive the rotating disk 221 and the second grating 222 to rotate at different speeds. This allows for the design of the reduction gear set to impart different rotational speeds to the rotating disk 221 and the second grating 222 to meet practical requirements.

For example, in some embodiments, the reduction gear set includes a first gear and a second gear arranged coaxially. The outer circumferences of both the rotating disk 221 and the second grating are provided with teeth for connecting with the reduction gear set, where the first gear meshes with the rotating disk 221, and the second gear meshes with the second grating. The output shaft of the drive motor may be directly connected with the rotating shaft of the first and second gears, allowing the drive motor to directly drive their rotation. In this embodiment, by setting different gear ratios between the first gear and the rotating disk 221 and between the second gear and the second grating, different rotational speeds for the rotating disk 221 and the second grating 222 may be achieved.

### Embodiment 4

To provide users with an immersive experience, the inventors of the present application have made optimized designs based on the above embodiments to further enhance the projection effect of the atmosphere image projection apparatus. The atmosphere image projection apparatus may include a speaker and a controller. The controller is communicatively connected with the display screen 12, the speaker, and the light source assembly 11. The controller is used to provide video signals to the display screen 12 and audio signals to the speaker. The controller is also used to adjust the intensity or frequency of the light emitted by the light source assembly 11 based on the waveform of the audio signal. This embodiment allows the light intensity of the dynamic image projected by the display projection module 1 to vary with the music through the controller, providing users with a dual enjoyment of sight and sound and enhancing interactivity. For example, when the music is soft, the light source assembly 11 may be dimmed accordingly; when the music is loud, it may be brightened. When the music tempo is slow, the light source assembly 11 may flash at a lower frequency; when the tempo is fast, it may flash at a higher frequency.

In one embodiment, the controller may also be used to adjust the color of the light emitted by the light source assembly 11 based on the RGB color of the video signal. The colors displayed by the display screen 12 are varied. By analyzing its primary color, the color of the light emitted by the light source assembly 11 may be adjusted. For example, if the primary color displayed by the display screen 12 is blue, the light source assembly 11 may emit white or yellow light to increase the contrast of the overall projection effect. It can be understood that the greater the contrast, the clearer and more striking the image, and the more vivid and brilliant the colors, which is beneficial for improving the user experience.

In this embodiment, the controller may be a microcontroller chip integrated into the control circuit board of the light source assembly 11, or it may be set up separately. The controller may obtain control signals through button switches, wireless signal transceivers, or other mechanisms to control the intensity of the light from the light source assembly 11. Additionally, the control circuit board may rely on a DC drive to supply power to the light source assembly 11.

### Embodiment 5

The present application also provides a method of atmosphere image projection, including:
passing a single laser beam emitted from a laser assembly 21 through a first optical path module 22 to form a plurality of laser beams and be projected into space; and
guiding content played on a display screen 12 via a second optical path module 13 to form dynamic image and projecting it between the plurality of laser beams.

The content played on the display screen 12 can form dynamic image and be projected into space. The single laser beam from the laser assembly 21 passes through the first optical path module 22 to form a plurality of laser beams and is projected into space. The plurality of laser beams illuminate space to form a starry sky image. The starry sky image and the dynamic image at least partially overlap in space. The starry sky image has a large coverage area, thus providing a more expansive dynamic visual experience. By projecting imagery via the display screen 12, there is no need to set up films, resulting in lower costs, and the display screen 12 may offer a richer and more diverse selection of imagery with natural transitions and convenient operation. Compared to the prior art, this embodiment, by combining the starry sky image and the dynamic image, compensates for the defect of the narrow visible range of the dynamic image and avoids the defect of the starry sky image feeling monotonous due to too little variation by combining the starry sky image and the dynamic image. The complementary combination of the two significantly enhances the user experience.

Compared to the prior art, this embodiment projects imagery via the display screen 12, obviating the need for films, which results in lower costs. Furthermore, the display screen 12 can provide a richer and more diverse selection of imagery, with natural image transitions and convenient operation, thereby significantly enhancing the user experience.

In this embodiment, the atmosphere image projection method may also include:
providing a video signal to the display screen 12 and an audio signal to a speaker;
adjusting the intensity or frequency of the light from the light source assembly 11 entering the second optical path module 13 based on the waveform of the audio signal;
adjusting the color of the light from the light source assembly 11 entering the second optical path module 13 based on the RGB color of the video signal.

The light intensity of the dynamic image projected by the display projection module 1 varies with the music, providing users with a dual enjoyment of sight and sound and enhancing interactivity. This implementation may increase the degree of contrast between the foreground and background of the overall projection effect by analyzing the primary color of the display screen 12 to adjust the color of the light from the light source assembly 11 entering the second projection mechanism. It can be understood that the greater the degree of contrast, the clearer and more striking the foreground dynamic image, and the more vivid and brilliant the colors, thereby providing a more impactful visual effect.

For those skilled in the art, it is apparent that the present application is not limited to the details of the foregoing exemplary embodiments, and that the present application can be embodied in other specific forms without departing from the spirit or essential characteristics thereof. The present embodiments are therefore to be considered in all respects as illustrative and not restrictive, the scope of the application being indicated by the appended claims rather than by the foregoing description, and all changes which come within the meaning and range of equivalency of the claims are therefore intended to be embraced therein. Any reference numerals in the claims should not be construed as limiting the claim concerned.

1. An atmosphere image projection apparatus, comprising:
a display projection module and a laser projection module provided adjacent to said display projection module;
wherein said laser projection module comprises a laser assembly and a first optical path module, and a single laser beam emitted from said laser assembly passes through said first optical path module to form a plurality of laser beams and is projected into space;
wherein said display projection module comprises a light source assembly, a display screen, and a second optical path module, and content played on said display screen is guided by said second optical path module to form a dynamic image, which is projected between said plurality of laser beams.

2. The atmosphere image projection apparatus according to claim 1, wherein, said first optical path module comprises:
a first grating and a second grating provided along an optical path of said laser;
wherein the single laser beam emitted from said laser assembly is diffracted by said first grating into a plurality of laser beams, and then the plurality of laser beams are secondarily diffracted by said second grating to form an irregular optical path.

3. The atmosphere image projection apparatus according to claim 2, wherein, a density of a diffraction pattern of said first grating is greater than a density of a diffraction pattern of said second grating.

4. The atmosphere image projection apparatus according to claim 2, wherein, said first optical path module further comprises:
a rotating shaft and a rotating disk sleeved on said rotating shaft, wherein said rotating disk is capable of being driven to rotate on said rotating shaft, said rotating disk is located between said first grating and said second grating, and said rotating disk is provided with a plurality of light-passing apertures for said laser to pass through.

5. The atmosphere image projection apparatus according to claim 4, wherein, diameters of said plurality of light-passing apertures are of different sizes; and/or,
said plurality of light-passing apertures are distributed on said rotating disk in an irregular manner.

6. The atmosphere image projection apparatus according to claim 4, wherein, said second grating is connected with said rotating disk to rotate therewith.

7. The atmosphere image projection apparatus according to claim 6, characterized in that, said laser projection module further comprises: a drive assembly, connected with said rotating disk to rotate along with said rotating disk.

8. The atmosphere image projection apparatus according to claim 7, wherein, said drive assembly comprises:
a drive motor;
a reduction gear set, connected with said drive motor, wherein said reduction gear set is connected with said rotating disk and said second grating, respectively, to drive said rotating disk and said second grating to rotate at different speeds.

9. The atmosphere image projection apparatus according to claim 1, wherein, said light source assembly comprises a first light source and a light-focusing element;
said second optical path module comprises an optical lens and several lenses; and
said first light source, said light-focusing element, said display screen, and said optical lens are arranged sequentially along an optical path followed by said second optical path module.

10. The atmosphere image projection apparatus according to claim 9, wherein, said display screen is a liquid crystal display screen, and the light emitted from said light source assembly illuminates said liquid crystal display screen to serve as a backlight.

11. The atmosphere image projection apparatus according to claim 9, wherein, said lenses comprise:
a first lens, provided between said light-focusing element and said display screen; and
a second lens, provided between said display screen and said optical lens;
wherein said optical lens comprises a convex lens, a concave lens, and a fisheye lens, arranged sequentially along an optical path followed by said second optical path module.

12. The atmosphere image projection apparatus according to claim 11, wherein, said second optical path module further comprises a reflecting mirror, said reflecting mirror is provided between said second lens and said optical lens, and said reflecting mirror is provided at an angle with respect to said display screen.
